(19) United States
(12) Patent Application Publication
(10) Pub. No.: US 2017/0236070 A1
(43) Pub. Date: Aug. 17, 2017

(54) METHOD AND SYSTEM FOR CLASSIFYING INPUT DATA ARRIVED ONE BY ONE IN TIME

(71) Applicant: FUJITSU LIMITED, Kawasaki-shi (JP)

(72) Inventors: Zhuoran XU, Beijing (CN); Cuiqin HOU, Beijing (CN); Yingju XIA, Beijing (CN); Jun SUN, Beijing (CN)

(73) Assignee: FUJITSU LIMITED, Kawasaki-shi (JP)

(21) Appl. No.: 15/406,916

(22) Filed: Jan. 16, 2017

(30) Foreign Application Priority Data
Feb. 14, 2016 (CN) 201610084957.8

(51) Int. Cl. G06N 99/00

(52) U.S. Cl. CPC G06N 99/005

(57) ABSTRACT

A method and system for classifying input data arrived one by one in time, is provided including: a) respectively training a group of classifiers with a predetermined number with recent or previous input data whose real classes are obtained as learning samples, wherein a number of the recent input data are increased progressively in reverse chronological order; b) selecting the classifier having the highest accuracy on the recent input data from the group of classifiers based on recent classifying results of the group of classifiers; and c) classifying current input data using the selected classifier.

### CROSS-REFERENCE TO RELATED APPLICATIONS

This application claims the priority benefit of Chinese Patent Application No. 201610084957.8, filed on Feb. 14, 2016 in the Chinese State Intellectual Property Office, the disclosure of which is incorporated herein in its entirety by reference.

### BACKGROUND

1. Field

The embodiments relate to a classification method and system, and particularly to a method and system for classifying input data arrived one by one in time.

2. Description of the Related Art

Online learning, which is a machine learning method for continuously learning new data and updating an existing model, has wide application fields, for example stream data mining.

Concept drift is a problem specific to online learning, and it refers to presence of a conflict between chronologically preceding and subsequent data concepts, making it impossible to make descriptions using one machine learning model. Continuous changes in the real world are the root of the concept drift. For example, in a classification application of junk mail, mail about new-year sales promotion would be taken as junk mail from February to October but would be taken as common mails from November to December.

Referring to FIG. 1, FIG. 1 illustrates a schematic view of a typical existing online learning method 100. In the method 100, each time new data 110 is obtained (step 101), a classifier 120 is invoked first to classify the new data (step 102). The classifier 120 herein is a classifier in machine learning, such as a support vector machine, a decision tree, a K-nearest neighbor, a neural network and so on. A classifying result 130 is fed to a user or other programs as an output (step 103). Next, a real class of the data is obtained (step 104). The method for obtaining the real class may either be automatic obtainment or be manual feedback. If a real class 140 of certain data cannot be obtained, continued implementation of the method would not be influenced. The method 100 would skip over the data, and would not use the data to update the classifier 120.

Next, concept drift shall be detected and handled (step 105). Firstly, concept drift is detected (step 105a), wherein upon detection of the concept drift, the classifier 120 is updated, for example a portion in the classifier 120 which corresponds to an old concept is detected. Finally, the classifier is updated using the data and the real class thereof (step 105b).

The existing online learning method detects the concept shift using statistics or a dimension reduction method, with limited detection accuracy. It is also difficult to determine which portion of the classifier corresponds to the old concept. Due to these problems, classification accuracy of the existing online learning method and system is limited.

As can be seen from the above, the existing online learning method cannot realize data classification excellently due to the presence of the concept drift.

It is thus desired to provide a classification method and system having the capability of handling concept drift.

### SUMMARY

Additional aspects and/or advantages will be set forth in part in the description which follows and, in part, will be apparent from the description, or may be learned by practice of the embodiments.

A brief summary of the embodiments is given below to provide a basic understanding of some aspects of the embodiments. It should be understood that the summary is not exhaustive; it does not intend to define a key or important part of the embodiments, nor does it intend to limit the scope of the embodiments. The object of the summary is only to briefly present some concepts, which serves as a preamble of the detailed description that follows.

To solve the above problems, the embodiments provide a method and system for classifying input data arrived one by one in time.

According to one aspect, there is provided a method for classifying input data arrived one by one in time, comprising: a) respectively training a group of classifiers with a predetermined number with recent input data whose real classes are obtained as learning samples, wherein a number of the recent input data are increased progressively in reverse chronological order; b) selecting the classifier having the highest accuracy on the recent input data from the group of classifiers based on recent classifying results of the group of classifiers; and c) classifying current input data using the selected classifier.

According to another aspect, there is provided a system for classifying input data arrived one by one in time, comprising: a training means respectively training a group of classifiers with a predetermined number with recent input data whose real classes are obtained as learning samples, wherein a number of the recent input data are increased progressively in reverse chronological order; a selecting means selecting the classifier having the highest accuracy on the recent input data from the group of classifiers based on recent classifying results of the group of classifiers; and a classifying means classifying current input data using the selected classifier.

As compared with the prior art, the method and system as proposed do not require special detection of concept shift, and can automatically handle the concept shift. Additionally, the classification accuracy can be improved by using the method and system as proposed to classify the input data.

By describing preferred embodiments in detail in combination with the appended drawings below, the above and other advantages will become more apparent.

### BRIEF DESCRIPTION OF THE DRAWINGS

To further set forth the above and other advantages and features, embodiments are further described in detail in combination with the drawings below. The drawings together with the detailed descriptions below are included in the specification and constitute a part of the specification. Elements having identical functions and structures are denoted by the same reference numeral. It should be understood that the drawings only describe typical examples but shall not be construed as limitations to the scope of the embodiments. In the accompanying drawings:

FIG. 1 is a schematic view illustrating a typical existing online learning method;

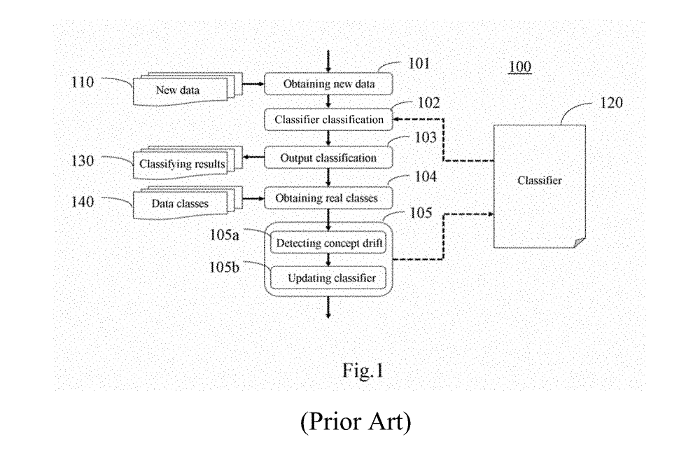

FIG. 2 is a schematic view illustrating a method for classifying input data arrived one by one in time according to one embodiment;

FIG. 3 is a schematic view illustrating how to train classifiers using input data according to one embodiment;

FIG. 4 is a schematic view illustrating how to select the classifier having the highest accuracy according to a preferred embodiment;

FIG. 5 is a schematic view illustrating a system for classifying input data arrived one by one in time according to one embodiment;

FIG. 6 is a schematic view illustrating a system for classifying input data arrived one by one in time according embodiments to another embodiment;

FIG. 7 is a schematic view illustrating a selecting means in the system for classifying input data arrived one by one in time according to one embodiment;

FIG. 8 is a schematic block diagram illustrating a computer for implementing the method and system according to the embodiments.

### DETAILED DESCRIPTION

Reference will now be made in detail to the embodiments, examples of which are illustrated in the accompanying drawings, wherein like reference numerals refer to the like elements throughout. The embodiments are described below by referring to the figures.

Exemplary embodiments will be described combined with the appended drawings below. For the sake of clarity and conciseness, the specification does not describe all features of actual embodiments. However, it should be understood that in developing any such actual embodiment, many decisions specific to the embodiments must be made, so as to achieve specific objects of a developer, for example, those limitation conditions related to the system and services are met, and these limitation conditions possibly would vary as embodiments are different. In addition, it should be appreciated that although developing tasks are possibly complicated and time-consuming, such developing tasks are only routine tasks for those skilled in the art benefiting from the contents of the disclosure.

It should also be noted herein that, to avoid the embodiments from being obscured due to unnecessary details, only those device structures and/or processing steps closely related to the solution are shown in the appended drawings, while omitting other details not closely related to the embodiments.

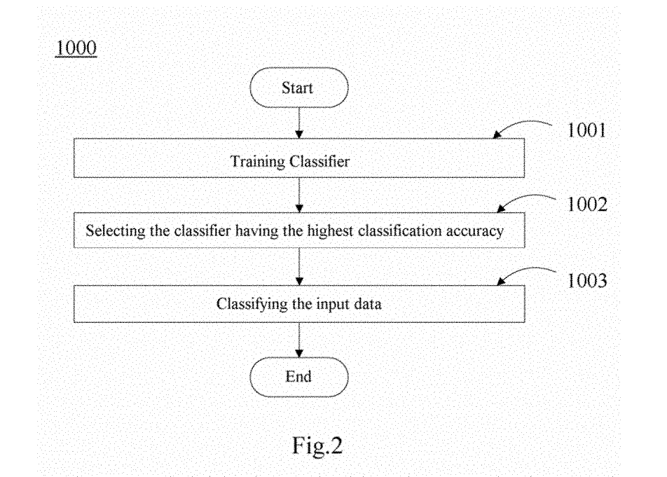

Referring first to FIG. 2, FIG. 2 is a schematic view illustrating a method 1000 for classifying input data arrived one by one in time according to one embodiment. As shown in FIG. 2, the method 1000 comprises the steps of: training classifiers (step 1001), selecting the classifier having the highest classification accuracy (step 1002) and classifying input data (step 1003). This method improves the operation of a computer in performing data classification.

According to the method 1000, a group of classifiers with a predetermined number are first trained respectively with respective sets of recent or previous input data whose real classes are obtained as learning samples, wherein among the sets of recent or previous input data, a number of the recent input data are increased progressively in reverse chronological order (step 1001), wherein the number C of the classifiers is a parameter that shall be predetermined, and the classifiers may be any machine learning classifier, such as a support vector machine, a decision tree, a K-nearest neighbor, a neural network and so on. More particularly, the classifiers may be SVM Classifier, Random Forest Classifier, Decision Tree Classifier, KNN Classifier and Naive Bayes Classifier. The embodiments are not limited to the above, and those skilled in the art can select appropriate classifiers according to actual requirements.

In addition, the C classifiers may be identical classifiers or different classifiers; that is, one type of classifiers may be used, and a plurality of types of classifiers may also be used mixedly.

In a preferred embodiment, the step 1001 is performed after accumulating a predetermined number of recent input data whose real classes are obtained.

In a preferred embodiment, the number Sᵢ of the learning samples for training each classifier in the group of classifiers with a predetermined number in the step 1001 is calculated by the following equation:

Sᵢ=i*N

wherein i=1, . . . C, C represents the number of the classifiers in the group of classifiers, and N represents the number of the recent input data for training the first classifier in the group of classifiers.

In a preferred embodiment, a first classifier in the C classifiers is set to be trained using N recent input data, a second classifier is set to be trained using 2N recent input data, et cetera. In the C classifiers, which classifier serves as the first one and which classifier serves as the second one would not influence an algorithm, and can be determined randomly. The algorithm is not limited to classifying the respective classifiers respectively using N, 2N and 3N input data increased progressively in such arithmetic progressions either, and any progressive increase manner is allowed.

When selecting training data, the selecting shall start from the latest data whose real classes are obtained. Hence, in the above preferred embodiment, training data of the first classifier is the latest N data, training data of the second classifier is the latest 2N data, et cetera. Training data selected in this manner can ensure that: there is always a group of training data which most satisfy current data distribution whenever concept drift occurs. A classifier trained using this group of training data is also most adaptive to the current distribution. That is, this classifier would have the highest classification accuracy on the group of the latest data. Hence, a classifying result thereof will be selected as a fused result by a classifier fusion method.

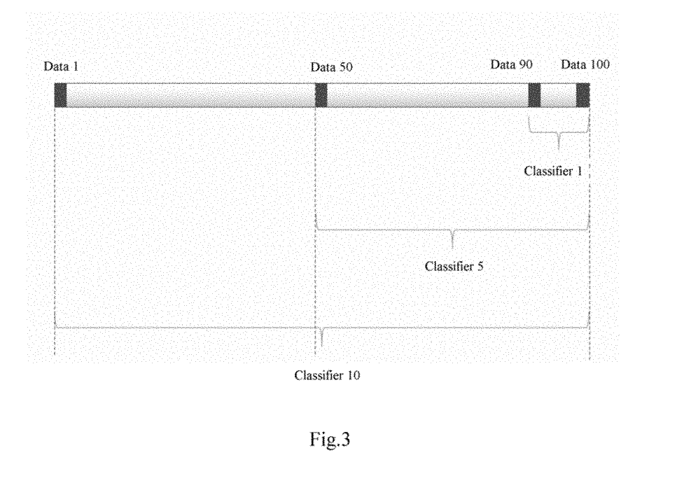

Referring to FIG. 3, FIG. 3 is a schematic view illustrating how to train classifiers using input data according to one embodiment. It is supposed that the 101th data is being classified currently while concept drift occurs at the 50th data. Taking the foregoing preferred embodiment as an example, training data of the first, fifth and tenth classifiers are as shown in FIG. 3 if N=10.

Since the concept drift occurs at the 50th data, and the training data of the tenth classifier contains data before and after the concept drift, classification accuracy of the tenth classifier on the current data distribution shall be relatively low. The training data of the fifth classifier contains all data after the concept drift, so classification accuracy of the fifth classifier shall be the highest. The training data of the first classifier only contains data after the drift, but the training data of the first classifier is relatively less, so classification accuracy of the first classifier shall be lower than that of the fifth classifier. In accordance with the classifier fusion algorithm, a classifying result of the fifth classifier shall be a fused result. The fusion for the classifying results will be described in detail in the following contents.

Next, upon completion of the step 1001, the classifier having the highest accuracy on the recent input data is selected from the group of classifiers based on recent classifying results of the group of classifiers (step 1002). In a preferred embodiment, weight of each classifier in the group of classifiers is calculated based on a predetermined number of recent input data whose real classes are obtained, wherein, while a classifier gives a right class, the input data is more recent in time, the contribution thereof to the weight of the classifier is more large; and the classifier whose weight is the highest is selected as the classifier having the highest accuracy on the recent input data. Those skilled in the art would readily understand that the number M of the recent input data for calculating the weight of the classifier can be set according to actual application.

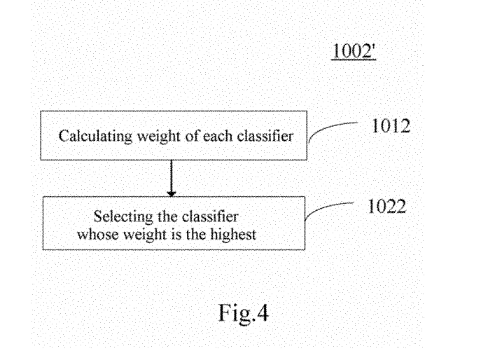

Referring to FIG. 4, FIG. 4 is a schematic view illustrating how to select the classifier having the highest accuracy according to a preferred embodiment. As shown in FIG. 4, a step 1002′ may comprise the steps of: calculating weight of each classifier in the group of classifiers based on a predetermined number of recent input data whose real classes are obtained (step 1002), and selecting the classifier whose weight is the highest from the classifiers according to the calculated weight (step 1022).

For example, if the number M of the recent input data for calculating the weight of the classifier is set to 5 and the data currently being processed is the 105th data, weight of each classifier is calculated using the 100th to 104th data whose real classes are obtained previously.

As would be readily understood by those skilled in the art, in a varied embodiment, the real classes of the recent input data may be obtained at fixed time or be obtained in batches. In this case, if a real class of the 104th data is not yet known when processing the 105th data, the weight is calculated using preceding input data whose real classes are obtained; for example, the weight of each classifier may be calculated using the 99th to 103th data. By such analogy, no description will be made redundantly herein.

In a further preferred embodiment, the weight W, of each classifier in the group of classifiers is calculated by the following equation in the step 1012:

$${W}_{i} = {\sum }_{k = 1}^{M} \frac{1}{k} p ( {r}_{k} , {l}_{k} )$$

wherein M represents the predetermined number of the recent input data whose real classes are obtained;
wherein k represents the kth recent input data in the recent input data whose real classes are obtained, k=1, . . . M;
wherein rₖ represents the classifying result of the ith classifier on the kth recent input data, and lₖ represents the real class of the kth recent input data; and
wherein when the classifying result of the ith classifier on the kth recent input data is right, p(rₖ,lₖ)=1, otherwise, p(rₖ,lₖ)=0.

How to calculate the weight of the classifier is described in detail below.

After new data is obtained, each classifier classifies the new data independently. Hence, C classifiers would generate C classifying results. The algorithm calculates a weight Wᵢ for each classifier according to a classifying result of each classifier on a recent batch of data whose real class is obtained and the real class thereof. Newer data would produce greater influence on the calculation of the weight; that is, a value of the parameter k in the above equation is smaller for more recent data. In other words, a k value corresponding to the most recent data is 1, a k value corresponding to the most recent data but one is 2, a k value corresponding to the most recent data but two is 3, et cetera.

After the weight of each classifier is obtained, a classifier having the greatest weight is found, and a classifying result of this classifier is used as a fused result.

In a preferred embodiment, it is supposed that data D6 is being processed, and the weight is calculated on the latest five data, that is, the value of M is 5. Prior to the data D6, data D1 to data D5 have been processed. In the data D1 to the data D5, the data D1 is the oldest data and a k value corresponding thereto is 5, while the data D5 is the newest data and a k value corresponding thereto is 1.

If classifying results of one classifier for the data D1 to the data D5 and actual classes of the data D1 to the data D5 are as shown in Table 1 below, and classifying results rₖ of the classifier for the respective data corresponding to Table 1 and values of real classes lₖ thereof are as shown in Table 2.

TABLE 1

| Data | D1 | D2 | D3 | D4 | D5 |
|---|---|---|---|---|---|
| Classifying Result | 1 | 2 | 3 | 4 | 5 |
| Real Class | 0 | 2 | 3 | 6 | 5 |

TABLE 2

| r₅ | r₄ | r₃ | r₂ | r₁ |
|---|---|---|---|---|
| 1 | 2 | 3 | 4 | 5 |
| l₅ | l₄ | l₃ | l₂ | l₁ |
| 0 | 2 | 3 | 6 | 5 |

When the classifier processes the data D6, the equation by which the weight is calculated based on the data D1 to the data D5 is shown as follows:

$${W}_{6} = {\sum }_{k = 1}^{5} \frac{1}{k} p ( {r}_{k} , {l}_{k} ) = \frac{1}{1} \times 1 + \frac{1}{2} \times 0 + \frac{1}{3} \times 1 + \frac{1}{4} \times 1 + \frac{1}{5} \times 0 = 1 \frac{7}{12}$$

Thus, the weight of each classifier is calculated as stated above, so as to select the classifier having the highest classification accuracy from the classifiers.

Then the method 1000 proceeds to the last step, i.e., classifying current input data using the selected classifier (step 1003).

In other embodiments, the method 1000 may further comprise storing the recent input data and the real classes thereof using a storage. Besides, in a preferred embodiment, the largest number Q of the recent input data stored by the storage is calculated by the following equation:

Q=C*N

In the foregoing various methods, the real classes of the input data can be fed by a user or obtained automatically.

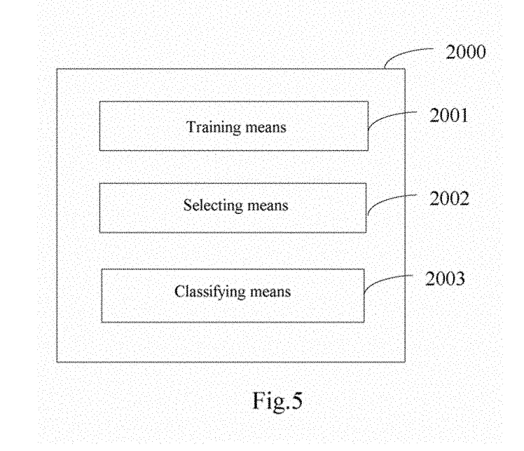

Referring to FIG. 5 below, FIG. 5 is a schematic view illustrating a system 2000 for classifying input data arrived one by one in time according to one embodiment. As shown in FIG. 5, a system 2000 comprises a training means or trainer 2001, a selecting means or selector 2002 and a classifying means or classifier 2003.

The training means 2001 respectively trains a group of classifiers with a predetermined number with recent input data whose real classes are obtained as learning samples, wherein a number of the recent input data are increased progressively in reverse chronological order. The selecting means 2002 selects the classifier having the highest accuracy on the recent input data from the group of classifiers based on recent classifying results of the group of classifiers. The classifying means 2003 classifies current input data using the selected classifier.

In a preferred embodiment, the group of classifiers are trained using the training means after accumulating a predetermined number of recent input data whose real classes are obtained.

In a preferred embodiment, the real classes are fed by a user or obtained automatically.

In a preferred embodiment, the classifiers in the group of classifiers may be identical or different.

In a preferred embodiment, the classifiers in the group of classifiers are selected from one or more of the following classifiers: SVM Classifier, Random Forest Classifier, Decision Tree Classifier, KNN Classifier and Naive Bayes Classifier. The embodiments are not limited to the above, and those skilled in the art can select appropriate classifiers according to actual requirements.

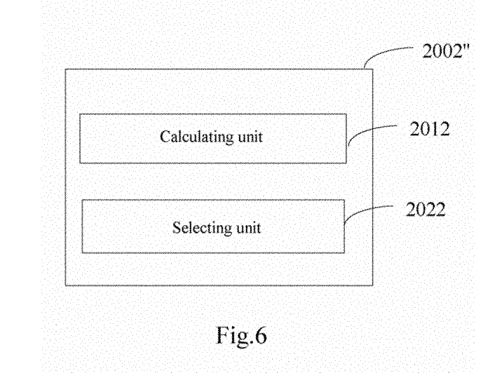

In a preferred embodiment, the selecting means 2002 calculates weight of each classifier in the group of classifiers based on a predetermined number of recent input data whose real classes are obtained, and selects the classifier in the classifiers whose weight is the highest according to the weight. Particularly, the selecting means 2002 selects the classifier whose weight is the highest as the classifier having the highest accuracy on the recent input data, wherein, while a classifier gives a right class, the input data is more recent in time, the contribution thereof to the weight of the classifier is more large. Referring to FIG. 6, FIG. 6 is a schematic view illustrating a selecting means in the system for classifying input data arrived one by one in time according to one embodiment. In the embodiment as shown in FIG. 6, the selecting means 2002″ in the system 2000 may comprise a calculating unit 2012 and a selecting unit 2022.

The calculating unit 2012 calculates weight of each classifier using a predetermined number of input data whose real classes are known. In a preferred embodiment, weight of each classifier can be calculated using the equation described previously in combination with the method implementation manner, which will not be described redundantly herein. Besides, the selecting unit 2022 is used for selecting the classifier whose weight is the highest from the classifiers based on the calculated weight, as the classifier having the highest accuracy.

In a preferred embodiment, a number of learning samples for training each classifier in a group of classifiers with a predetermined number may be calculated by the equation described previously in combination with the method implementation manner, which will not be described redundantly herein.

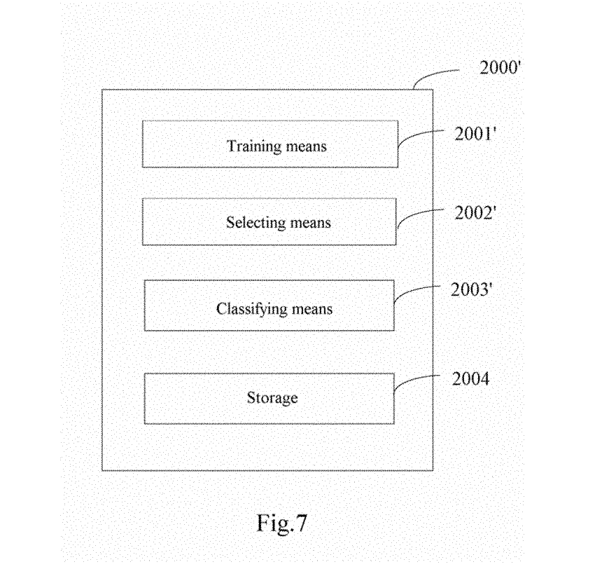

Referring now to FIG. 7, FIG. 7 is a schematic view illustrating a system 2000′ for classifying input data arrived one by one in time according to another embodiment. In the varied embodiment as shown in FIG. 7, the system 2000′ comprises a training means or trainer 2001′, a selecting means or selector 2002′, and a classifying means or classifier 2003′. As compared with the system 2000, the system 2000′ differs in further comprising a storage 2004. The storage 2004 is used for storing recent input data and real classes thereof. In a preferred embodiment, the largest number Q of the recent input data stored by the storage 2004 may be calculated by the equation described previously in combination with the implementation manner, which will not be described redundantly herein.

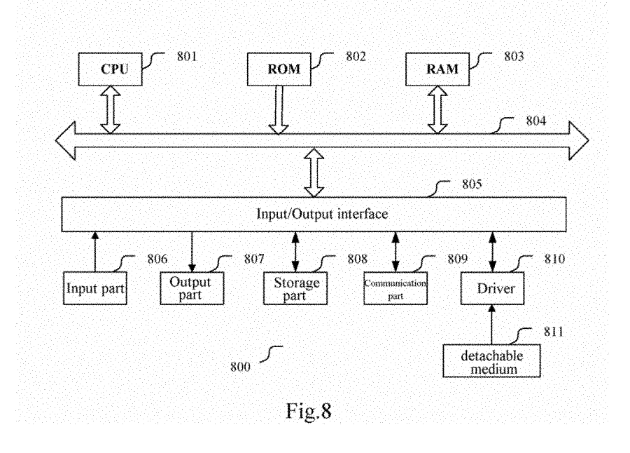

Referring next to FIG. 8, FIG. 8 is a schematic block diagram illustrating a computer for implementing the method and system according to the embodiments.

In FIG. 8, a central processing unit (CPU) 801 executes various processing according to a program stored in a read-only memory (ROM) 802 or a program loaded from a storage section 808 to a random access memory (RAM) 803. In the RAM 803, data needed when the CPU 801 executes various processing and the like is also stored according to requirements. The CPU 801, the ROM 802 and the RAM 803 are connected to each other via a bus 804. An input/output interface 805 is also connected to the bus 804.

The following components are connected to the input/output interface 805: an input part 806 (including a keyboard, a mouse and the like); an output part 807 (including a display, such as a Cathode Ray Tube (CRT), a Liquid Crystal Display (LCD) and the like, as well as a loudspeaker and the like); the storage part 808 (including a hard disc and the like); and a communication part 809 (including a network interface card such as an LAN card, a modem and so on). The communication part 809 performs communication processing via a network such as the Internet. According to requirements, a driver 810 may also be connected to the input/output interface 805. A detachable medium 88 such as a magnetic disc, an optical disc, a magnetic optical disc, a semiconductor memory and the like may be installed on the driver 810 according to requirements, such that a computer program read therefrom is installed in the storage part 808 according to requirements.

In the case of carrying out the foregoing series of processing by software, programs forming the software are installed from a network such as the Internet or a non-transitory computer readable storage medium such as the detachable medium 811.

It should be appreciated by those skilled in the art that that such a storage medium is not limited to the detachable medium 811 storing a program and distributed separately from the device to provide the program to a user as shown in FIG. 8. Examples of the detachable medium 811 include a magnetic disc (including floppy disc (registered trademark)), a compact disc (including compact disc read-only memory (CD-ROM) and digital versatile disc (DVD), a magneto optical disc (including mini disc (MD)(registered trademark)), and a semiconductor memory. Or, the storage medium may be hard discs and the like included in the ROM 802 and the storage part 708 in which programs are stored, and are distributed concurrently with the device including them to users.

The embodiments further provide a program product storing machine-readable instruction code. When being read and executed by a machine, the instruction code can carry out the method realized according to the principle and concept of the embodiments.

Accordingly, a storage medium for carrying the program product storing the machine-readable instruction code is also included in the disclosure of the embodiments. The storage medium includes but is not limited to a floppy disc, an optical disc, a magnetic optical disc, a memory card, a memory stick and the like.

### Typical Application Scenarios

The embodiments are applied mainly to the field of stream data mining, such as junk mail classification, stock rise-and-fall prediction, commodity recommendation, and so on. In these applications, the system on the one hand shall perform prediction (classification, recommendation and so on) and on the other hand shall perform update using newly obtained data.

In the classification task of junk mails, real classes come from user “marked junk mails” or “marked non-junk mails”. It should be noted that such marked data only occupy a small portion of all mails. Every week (or every several weeks), marked data of that week (or those weeks) are collected and are stored as training data. The frequency of updating classifiers may be weekly, monthly, or the like. Each time of update at least shall use data of the latest several months. When fusing classifying results, weight calculation at least uses data of nearly one week. Since the amount of weight calculation is large, re-calculation during each time of classification produces greater influence on efficiency, and the weight can be calculated every day or every several days.

The realization of stock rise-and-fall system is substantially the same as the realization of the junk mail classification in spite of a difference in that: actual rise-and-fall information can be obtained soon after each time of rise-and-fall prediction. Whether or not the rise-and-fall prediction is right thus can be obtained automatically, and data predicted each time will be stored as training data.

In commodity recommendation, multiple collaborative filtering modes are used, without using multiple classifiers. The training of the collaborative filtering modes differs from the training of the classifiers in that it only needs browsing data or order data of commodities but does not need data on whether or not recommendation is right. It is thus made possible to train multiple collaborative filtering modes directly on browsing data and order data of different times. When fusing recommendation results, history data on whether or not recommendation is right is still needed to calculate weight. Whether or not recommendation is right can be calculated by commodities, links and so on which are actually selected by the user.

It should also be noted that, in the device, method and system according to the embodiments, respective components or respective steps may be decomposed and/or re-combined. The decompositions and/or re-combinations shall be regarded as equivalent solutions of the embodiments. Besides, the above steps of the series of processing can be executed naturally in chronological order in the indicated order, but are not necessarily executed in chronological order. Some steps may be executed concurrently or independently of each other.

Finally, it should also be noted that, the term “comprise”, “include” or any other variant intends to cover non-exclusive inclusion, such that a process, a method, an article or a device including a series of elements not only includes those elements but also further includes other elements not explicitly listed or further includes elements intrinsic to such process, method, article or device. In addition, in the absence of more limitations, elements defined by expression “comprising one . . . ” do not exclude existence of additional identical elements in the process, method, article or device including the elements.

Although the embodiments are described above in detail combined with the accompany drawings, it should be understood that the embodiments described above are used only for describing the embodiments but fail to constitute limitations to the embodiments. Those skilled in the art can carry out various modifications and alternations on the above embodiments without departing from the spirit and scope of the embodiments. Hence, the scope of the embodiments is limited only by the appended claims and equivalent meanings thereof.

### Annexes

Annex 1: A method for classifying input data arrived one by one in time, comprising:
a) respectively training a group of classifiers with a predetermined number with recent input data whose real classes are obtained as learning samples, wherein a number of the recent input data are increased progressively in reverse chronological order;
b) selecting the classifier having the highest accuracy on the recent input data from the group of classifiers based on recent classifying results of the group of classifiers; and
c) classifying current input data using the selected classifier.

Annex 2: The method according to Annex 1, wherein the step b) further comprises:
calculating weight of each classifier in the group of classifiers based on a predetermined number of recent input data whose real classes are obtained, wherein, while a classifier gives a right class, the input data is more recent in time, the contribution thereof to the weight of the classifier is more large; and
selecting the classifier whose weight is the highest as the classifier having the highest accuracy on the recent input data.

Annex 3. The method according to Annex 2, wherein the weight Wᵢ of each classifier in the group of classifiers is calculated by the following equation:

$${W}_{i} = {\sum }_{k = 1}^{M} \frac{1}{k} p ( {r}_{k} , {l}_{k} )$$

wherein M represents the number predetermined of the recent input data whose real classes are obtained;
wherein k represents the kth recent input data in the recent input data whose real classes are obtained, k=1, . . . M;
wherein rₖ represents the classifying result of the ith classifier on the kth recent input data, and lₖ represents the real class of the kth recent input data; and
wherein when the classifying result of the ith classifier on the kth recent input data is right, p(rₖ,lₖ)=1, otherwise, p(rₖ,lₖ)=0.

Annex 4. The method according to Annex 1, wherein the number Sᵢ of the learning samples for training each classifier in the group of classifiers with a predetermined number in the step a) is calculated by the following equation:

Sᵢ=i*N

wherein i=1, . . . C, C represents the number of the classifiers in the group of classifiers, and N represents the number of the recent input data for training the first classifier in the group of classifiers.

Annex 5. The method according to Annex 3, further comprising storing the recent input data and the real classes thereof using a storage.

Annex 6: The method according to Annex 4, wherein the largest number Q of the recent input data stored by the storage is calculated by the following equation:

Q=C*N.

Annex 7: The method according to any of Annexes 1-6, wherein the step a) is performed after accumulating a predetermined number of recent input data whose real classes are obtained.

Annex 8: The method according to any of Annexes 1-6, wherein the real classes in the step a) are fed by a user or obtained automatically.

Annex 9: The method according to any of Annexes 1-6, wherein the classifiers in the group of classifiers are identical or different.

Annex 10: The method according to any of Annexes 1-6, wherein the classifiers in the group of classifiers are selected from one or more of the following classifiers: SVM Classifier, Random Forest Classifier, Decision Tree Classifier, KNN Classifier and Naive Bayes Classifier.

Annex 11: A system for classifying input data arrived one by one in time, comprising:
a training means respectively training a group of classifiers with a predetermined number with recent input data whose real classes are obtained as learning samples, wherein a number of the recent input data are increased progressively in reverse chronological order;
a selecting means selecting the classifier having the highest accuracy on the recent input data from the group of classifiers based on recent classifying results of the group of classifiers; and
a classifying means classifying current input data using the selected classifier.

Annex 12: The system as claimed in Annex 11, the selecting means calculates weight of each classifier in the group of classifiers based on a predetermined number of recent input data whose real classes are obtained, wherein, while a classifier gives a right class, the input data is more recent in time, the contribution thereof to the weight of the classifier is more large; and the selecting means selects the classifier whose weight is the highest as the classifier having the highest accuracy on the recent input data.

Annex 13: The system according to Annex 12, wherein the selecting means calculates the weight Wᵢ of each classifier in the group of classifiers is calculated by the following equation:
wherein N1 represents the number of the predetermined number of the recent input data whose real classes are obtained;

$${W}_{i} = {\sum }_{k = 1}^{M} \frac{1}{k} p ( {r}_{k} , {l}_{k} )$$

wherein k represents the kth recent input data in the recent input data whose real classes are obtained, k=1, . . . M;
wherein rₖ represents the classifying result of the ith classifier on the kth recent input data, and lₖ represents the real class of the kth recent input data; and
wherein when the classifying result of the ith classifier on the kth recent input data is right, p(rₖ,lₖ)=1, otherwise, p(rₖ,lₖ)=0.

Annex 14: The system according to Annex 11, wherein the number Sᵢ of the learning samples for training each classifier in the group of classifiers with a predetermined number is calculated by the following equation:

Sᵢ=i*N

wherein i=1, . . . C, C represents the number of the classifiers in the group of classifiers, and N represents the number of the recent input data for training the first classifier in the group of classifiers.

Annex 15: The system according to Annex 13, further comprising a storage for storing the recent input data and the real classes thereof.

Annex 16: The system according to Annex 14, wherein the largest number Q of the recent input data stored by the storage is calculated by the following equation:

Q=C*N.

Annex 17: The system according to any of Annexes 11-16, wherein the group of classifiers are trained using the training means after accumulating a predetermined number of recent input data whose real classes are obtained.

Annex 18: The system according to any of Annexes 11-16, wherein the real classes are fed by a user or obtained automatically.

Annex 19: The system according to any of Annexes 11-16, wherein the classifiers in the group of classifiers are identical or different.

Annex 20: The system according to any of Annexes 11-16, wherein the classifiers in the group of classifiers are selected from one or more of the following classifiers: SVM Classifier, Random Forest Classifier, Decision Tree Classifier, KNN Classifier and Naive Bayes Classifier.

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. A method for classifying input data arriving one by one in time, comprising:
respectively training a group of classifiers with a predetermined number of previous input data whose real classes are obtained as learning samples, wherein the number of the previous input data are increased progressively in a reverse chronological order;
selecting a classifier having a highest accuracy on the previous input data from the group of classifiers based on previous classifying results of the group of classifiers; and
classifying current input data using the classifier selected.

2. The method according to claim 1, wherein the selecting further comprises:
calculating a weight of each classifier in the group of classifiers based on the predetermined number of previous input data whose real classes are obtained, wherein, while the classifier gives a right class, the input data is more previous in time, a contribution thereof to the weight of the classifier is larger than for input data that is less previous in time; and
selecting the classifier whose weight is a highest as the classifier having the highest accuracy on the previous input data.

3. The method according to claim 2, wherein the weight Wi of each classifier in the group of classifiers is calculated by:
$${W}_{i} = {\sum }_{k = 1}^{M} \frac{1}{k} p ( {r}_{k} , {l}_{k} )$$
wherein M represents the number predetermined of the previous input data whose real classes are obtained;
wherein k represents a kth previous input data in the previous input data whose real classes are obtained, k=1, . . . M;
wherein rk represents a classifying result of an ith classifier on the kth previous input data, and lk represents a real class of the kth previous input data; and
wherein when the classifying result of the ith classifier on the kth previous input data is right, p(rₖ,lₖ)=1, otherwise, p(rₖ,lₖ)=0.

4. The method according to claim 1, wherein the number Si of learning samples for training each classifier in the group of classifiers with the predetermined number in the training is calculated by:
Si=i*N
wherein i=1, . . . C, C represents the number of the classifiers in the group of classifiers, and N represents the number of the previous input data for training the first classifier in the group of classifiers.

5. The method according to claim 3, further comprising storing the previous input data and the real classes thereof using a storage.

6. The method according to claim 4, wherein a largest number Q of the previous input data stored by the storage is calculated by:
Q=C*N.

7. The method according to claim 1, wherein the training is performed after accumulating the predetermined number of previous input data whose real classes are obtained.

8. The method according to claim 1, wherein the real classes in the training are one of provided by a user and obtained automatically.

9. The method according to claim 1, wherein the classifiers in the group of classifiers are one of identical and different.

10. The method according to claim 1, wherein the classifiers in the group of classifiers are selected from one or more of the following classifiers: SVM Classifier, Random Forest Classifier, Decision Tree Classifier, KNN Classifier and Naive Bayes Classifier.

11. A system for classifying input data arrived one by one in time, comprising:
a trainer respectively training a group of classifiers with a predetermined number of previous input data whose real classes are obtained as learning samples, wherein the number of the previous input data are increased progressively in a reverse chronological order;
a selecter selecting a classifier having a highest accuracy on the previous input data from the group of classifiers based on previous classifying results of the group of classifiers; and
a classifier classifying current input data using a classifier selected.

12. The system according to claim 11, the selecter calculates a weight of each classifier in the group of classifiers based on the predetermined number of previous input data whose real classes are obtained, wherein, while a classifier gives a right class, the input data is more previous in time, a contribution thereof to the weight of the classifier is larger than for input data less recent in time; and the selecter selects the classifier whose weight is a highest as the classifier having a highest accuracy on the previous input data.

13. The system according to claim 12, wherein the selecter calculates the weight Wᵢ of each classifier in the group of classifiers is calculated by the following equation:
$${W}_{i} = {\sum }_{k = 1}^{M} \frac{1}{k} p ( {r}_{k} , {l}_{k} )$$
wherein N1 represents the number of the predetermined number of the previous input data whose real classes are obtained;
wherein k represents a kth previous input data in the previous input data whose real classes are obtained, k=1, M;
wherein rₖ represents a classifying result of an ith classifier on the kth previous input data, and lₖ represents a real class of the kth previous input data; and
wherein when the classifying result of the ith classifier on the kth previous input data is right, p(rₖ,lₖ)=1, otherwise, p(rₖ,lₖ)=0.

14. The system according to claim 11, wherein the number Si of the learning samples for training each classifier in the group of classifiers with the predetermined number is calculated by:
Si=i*N
wherein i=1, . . . C, C represents the number of the classifiers in the group of classifiers, and N represents the number of the previous input data for training a first classifier in the group of classifiers.

15. The system according to claim 14, wherein a largest number Q of the previous input data stored by the storage is calculated by:
Q=C*N.

16. The system according to claim 11, wherein the group of classifiers are trained using the trainer after accumulating the predetermined number of previous input data whose real classes are obtained.

17. The method according to claim 1, wherein the method eliminates concept drift.

18. A method of data mining, comprising classifying current input data according to claim 1 and data mining using the current input data classified to eliminate concept drift.

19. A non-transitory computer readable storage medium storing codes which can be executed on a information processing equipment to implement a method according to claim 1.

20. A system for classifying input data arriving one by one in time, comprising:
a memory storing codes; and
a processor, the processor can execute the codes to:
respectively train a group of classifiers with a predetermined number of previous input data whose real classes are obtained as learning samples, wherein the number of the previous input data are increased progressively in a reverse chronological order;
select a classifier having a highest accuracy on the previous input data from the group of classifiers based on previous classifying results of the group of classifiers; and
classify current input data using a classifier selected.
